(19) United States
(12) Patent Application Publication
(10) Pub. No.: US 2017/0017642 A1
(43) Pub. Date: Jan. 19, 2017

(54) SECOND LANGUAGE ACQUISITION SYSTEMS, METHODS, AND DEVICES

(71) Applicant: SPEAK EASY LANGUAGE LEARNING INCORPORATED, Chicago, IL (US)

(72) Inventors: James Lance Cunningham, Chicago, IL (US); Scott Cameron Rupnow, Chicago, IL (US)

(21) Appl. No.: 15/213,028

(22) Filed: Jul. 18, 2016

Related U.S. Application Data
(60) Provisional application No. 62/193,768, filed on Jul. 17, 2015.

(51) Int. Cl. G06F 17/28

(52) U.S. Cl. CPC G06F 17/289; G06F 17/2872

(57) ABSTRACT

Systems, methods, and devices for second language acquisition, using incrementally increasing in-line word and grammar substitution to increase comprehension and retention by presenting new material in an already-understood context. The systems, methods, and devices may be implemented in a range of embodiments, from books to computer systems, and generally use isolated word and phrase substitution with a translated word/phrase in the context of a base language document to convey the meaning of the translated word/phrase to the user by context.

### CROSS-REFERENCE TO RELATED APPLICATIONS

This application claims benefit of U.S. Provisional Patent Application No. 62/193,768, filed Jul. 17, 2015, the entire disclosure of which is incorporated herein by reference.

### BACKGROUND OF THE INVENTION

Field of the Invention

The invention generally relates to second language instructional aids.

Description of the Related Art

Learning a second language has many benefits for an individual, including academic, cultural, and professional. However acquiring a second language, especially in adulthood, is exceedingly difficult using standard techniques. Standard techniques include rote memorization of foreign vocabulary words out of context and blocks of foreign text for the learner to translate. These methods require large amounts of concentration and mental effort, yet yield small amounts of language acquisition.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Wherefore, it is an object of the present invention to overcome the above mentioned shortcomings and drawbacks associated with the prior art.

Another object of the present invention is to teach users a new language by weaving a foreign language into their everyday lives. Slowly transitioning from an individual's primary language to a foreign language over the course of an article, novel, movie, season of a sitcom, etc. The individual learns foreign language vocabulary through context and repetition of foreign words.

Described herein, among other things, is a method of partially translating an electronic document comprising: providing a client computer having a display; providing a remote computer server communicatively coupled to the client computer device over a telecommunications network; receiving at the client computer an electronic document comprising written content in a first language; at the client computer, selecting a plurality of words in the written content and, for each such selected word, counting the number of times the word occurs in the written language content; at the client computer, sending to the remote computer a first datagram comprising the selected plurality of words and the count of occurrences of each of the plurality of words; receiving from the remote computer a second datagram comprising: a second plurality of words, the second plurality of words being a subset of the first plurality of words; for each word in the second plurality of words, a corresponding translation of the word into a second language; and at the client computer, displaying the received electronic document on the display, the displayed electronic document modified such that each occurrence in the displayed electronic document of a word in the second plurality of words is substituted for the corresponding translation of the word into the second language.

In an embodiment of the method, the client computer is a mobile device.

In a further embodiment of the method, the client computer is a smart phone or tablet computer.

In another embodiment of the method, the received electronic document is as web page.

In another embodiment of the method, the proportion of the selected plurality of words in the written content translated into the second language in the second plurality of words increases over time.

Also described herein, among other things, is a system for partially translating an electronic document comprising: an application server computer comprising a microprocessor and a non-transitory computer-readable storage medium having computer-readable instructions thereon which, when executed by the microprocessor, perform the steps of receiving at the server a request including a word list comprising a plurality of words in a first language and, for each word in the word list, a count of occurrence of the each word in a document; selecting as plurality of words in the word list for translation, the selected plurality of words being based at least in part upon the count of occurrences for each word in the selected plurality of words; determining as translation of the each word in the selected plurality of words into a second language; and responding to the received word list with a second word list comprising the selected plurality of words and, for each the word in the selected plurality of words, the determined translation of the each word.

In an embodiment of the system, the request further comprises a user identifier associated with a user.

In another embodiment of the system, selecting a plurality of words in the word list for translation is further based at least in part upon user profile data for the user associated with the user identifier.

In another embodiment of the system, selecting a plurality of words in the word list for translation is further based at least in part upon historical data about counts of occurrences for each word in the selected plurality of words for the user associated with the user identifier.

In another embodiment of the system, selecting a plurality of words in the word list for translation is further based at least in part upon a preset curriculum of words.

In another embodiment of the system, selecting as plurality of words in the word list for translation is further based at least in part upon words identified by an instructor for translation for the user associated with the user identifier.

In another embodiment of the system selection a plurality of words in the word list for translation is further based at least in part upon customization and configuration data provided by the user associated with the user identifier.

In another embodiment of the system, selecting a plurality of words in the word list for translation is further based at least in part upon words identified for translation by the user associated with the user identifier.

Also described herein, among other things, is a method for partially translating at electronic document comprising: providing an application server computer; receiving at the server a request including a word list comprising a plurality of words in a first language and for each word in the word list, a count of occurrence of the each word in as document; the application server selecting a plurality of words in the word list for translation, the selected plurality of words being based at least in part upon the count of occurrences for each word in the selected plurality of words; the application server determining a translation of the each word in the selected plurality of words into a second language; and the application server responding to the received word list with a second word list comprising the selected plurality of words and, for each the word in the selected plurality of words, the determined translation of the each word.

In an embodiment of the method, the request further comprises a user identifier associated with a user.

In another embodiment of the method, selecting a plurality of words in the word list for translation is further based at least in part upon user profile data for the user associated with the user identifier.

In another embodiment of the method, selecting a plurality of words in the word list for translation is further based at least in part upon historical data about counts of occurrences for each word in the selected plurality of words for the user associated. with the user identifier.

In another embodiment of the method, selecting a plurality of words in the word list for translation is further based at least in part upon a preset curriculum of words.

In another embodiment of the method, selecting a plurality of words in the word list for translation is further based at least in part upon words identified, by an instructor for translation for the user associated with the user identifier.

In another embodiment of the method, selecting a plurality of words in the word list for translation is further based at least in part upon words identified for translation by the user associated with the user identifier.

### BRIEF DESCRIPTION OF DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which;

FIG. 1 is an illustration of book page showing a beginning of a story and three separate locations where target language words are introduced;

FIG. 2 is an illustration of book page showing an ending portion of the story in FIG. 1;

FIGS. 3A and 3B are representations of a computer e-book reader;

FIG. 4 is a block diagram of a computing system operable to execute the module in accordance with the disclosed invention;

FIGS. 5-6 illustrate an example wearable computing system for receiving, transmitting, and displaying data according to the disclosed invention;

FIGS. 7-8 illustrate alternate examples of wearable computing systems according to the disclosed invention;

FIG. 9 illustrates an example schematic of a wearable computing system for use with aspects of the disclosure;

FIG. 10 illustrates an embodiment of a method for translating phrases from a base language to a target language;

FIG. 11 illustrates an embodiment of a system and method for translating particular words in an electronic document;

FIG. 12 illustrates an embodiment of another system and method for translating particular words in an electronic document; and

FIG. 13 illustrates an embodiment of still another system and method for translating particular words in an electronic document.

### DETAILED DESCRIPTION OF INVENTION

The present invention will be understood by reference to the following detailed description, which should be read in conjunction with the appended drawings. It is to be appreciated that the following detailed description of various embodiments is by way of example only and is not meant to limit, in any way, the scope of the present invention.

Generally, described herein are systems, methods, and devices for second language acquisition. These systems, methods, and devices assist a user or learner, who is already fluent in one language, usually a native tongue acquired from birth, to learn another language through incrementally increasing in-line word and grammar substitution. This increases comprehension and retention by presenting new terms from the foreign in an already-understood context. The systems, methods, and devices may be implemented in a range of embodiments, from simple books to complex computer systems.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited, to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples to non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program fir use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth t and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on a local computer, partly on the local computer, as a stand-alone software package, partly an as local computer and partly on a remote computer, or entirely on the remote computer or server, in the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to pm duce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus may provide processes for implementing the functions/acts specified in the flowchart and/or block diagram block or blocks.

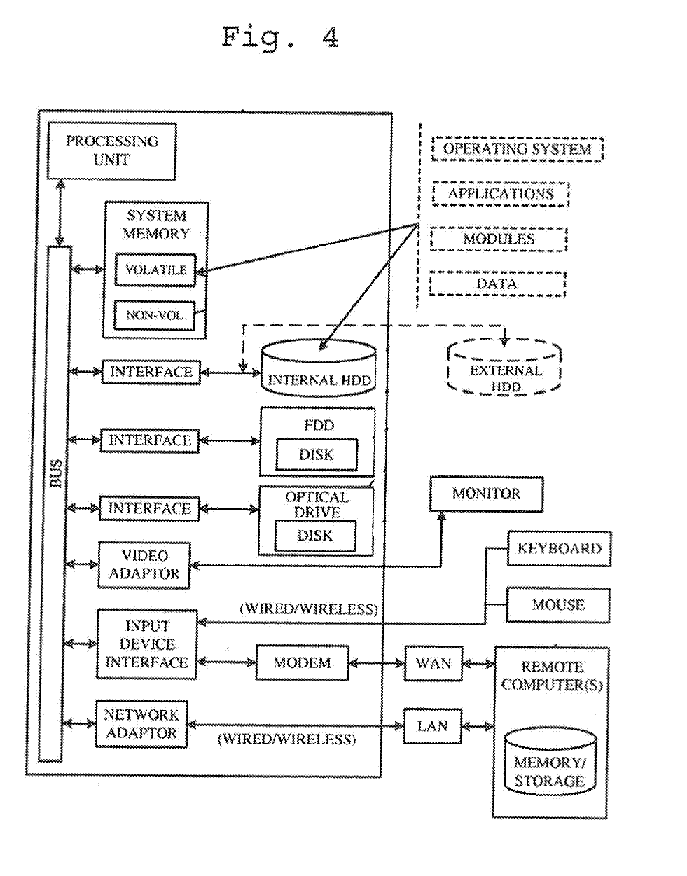

Referring now to FIG. 4, there is illustrated a block diagram of a computing system operable to execute a program or module. In order to provide additional context for various aspects thereof, FIG. 4 and the following discussion are intended to provide a brief, general description of a typical computing system in which the various aspects of this disclosure may be implemented. While the description above is in the general context of computer-executable instructions that may run on one or more computers, those skilled in the art will recognize that a novel embodiment also can be implemented in combination with other program modules and/or as a combination of hardware and software.

The exemplary computing system for implementing various aspects of the method and system includes a computer having a processing unit, a system memory and a system bus. This computer can be representative of a client computer and/or user device, such as an e-book reader, smartphone, or tablet computer, and/or a social media server. The system bus provides an interface for system components including, but not limited to the system memory to the processing unit. The processing unit can be any of various commercially available processors. Multi-processor and multi-core architectures may also be employed as the processing unit.

The system bus can be any of several types of bus structure that may further interconnect to a memory bus (with or without a memory controller), a peripheral bus, and a local bus using any of a variety of commercially available bus architectures. The system memory can include non-volatile memory (NON-VOL) and/or volatile memory (e.g., random access memory RAM)). A basic input/output system (BIOS) can be stored in the non-volatile memory (e.g., ROM, EPROM, EEPROM, etc.), which BIOS are the basic routines that help to transfer information between elements within the computer, such as during start-up. The volatile memory can also include a high-speed RAM such as static RAM for caching data.

The computer further preferably includes an internal hard disk drive (HDD) (e.g., EIDE, SATA, solidstate), which internal HDD may also be configured for external use in a suitable chassis, as magnetic floppy disk drive (FDD), (e.g., to read from or write to a removable diskette) and an optical disk drive, (e.g., reading a CD-ROM disk or to read from or write to other high capacity optical media such as a DVD). The HDD, FDD and optical disk drive can be connected to the system bus by a HDD interface, an FDD interface and art optical drive interface, respectively. The HDD interface for external drive implementations can include at least one or both of Universal Serial Bus (USB) and IEEE 1394 interface technologies.

The drives and associated computer-readable media provide non-volatile storage of data, data structures, computer-executable instructions, and so forth. For the computer, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory, including an operating system, one or more application programs, other program modules, and program data. The one or more application programs, other program modules, and program data can include the second language acquisition system. All or portions of the operating system, applications, modules, and/or data can also be cached in the volatile memory.

A user can enter commands and information into the computer through one or more wire/wireless input devices, for example, a keyboard and a pointing device, such as a mouse. Other input devices (not shown) may include a microphone, an IR remote control, a joystick, a game pad, a stylus pen, touch screen, or the like. These and other input devices are often connected to the processing unit through an input device interface that is coupled to the system bus, but can be connected by other interfaces such as a parallel port, IEEE 1394 serial port, a game port, a USB port, an IR interface, etc. A monitor or other type of display device is also connected to the system bus via an interface, such as a video adaptor. In addition to the monitor, a computer typically includes other peripheral output devices (not shown), such as speakers, printers, etc.

The computer may operate in a networked environment using logical connections via wire and/or wireless communications to one or more remote computers, such as a remote computer(s). The remote computer(s) can be a workstation, a server computer, a router, a personal computer, portable computer, microprocessor-based entertainment appliance, a peer device or other common network node, and typically includes many or all of the elements described relative to the computer, although, for purposes of brevity, only a memory/storage device is illustrated. The logical connections depicted include wire/wireless connectivity to a local area network (LAN) and/or larger networks, for example, a wide area network (WAN). Such LAN and WAN networking, environments are commonplace in offices and companies, and facilitate enterprise-wide computer networks, such as intranets, all of which may connect to a global communications network, for example, the Internet. It is to be understood that in one embodiment, the computer may also act in a stand-alone capacity, unconnected to a wider network.

When used in a LAN networking environment, the computer is connected to the LAN through a wire and/or wireless communication network interlace or adaptor. The adaptor can facilitate wire and/or wireless communications to the LAN, which may also include a wireless access point disposed thereon for communicating with the wireless functionality of the adaptor.

When used in a WAN networking environment, the computer can include a modem, or is connected to a communications server on the WAN, or has other means for establishing communications over the WAN, such as by way of the Internet. The modem, which can be internal or external and a wire and/or wireless device, is connected to the system bus via the input device interface. In a networked environment, program modules depicted relative to the computer, or portions thereof can be stored in the remote memory/storage device. It will be appreciated that the network connections shown are exemplary and other means of establishing a communications link between the computers can be used.

The computer is operable to communicate with wired and wireless devices or entities using radio waves. By way of example and not limitation, the IEEE 802 family of standards facilitate wireless communication (e.g., IEEE 802.11 over-the-air modulation techniques) with, for example, a printer, scanner, desktop and/or portable computer, personal digital assistant (PDA), smartphone or other mobile computer, communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

Throughout this disclosure, the term “eBook,” and similar terms such as an e-book, also called electronic book, eBook, e-Book, ebook, digital book, or even c-edition, means a normally book-length publication in digital form, consisting of text, images, or both, readable on computers or other electronic devices. Although sometimes defined as an electronic version of a printed book, the e-books do not require a printed equivalent. E-books are commonly read on dedicated e-readers, such as the Nook® or the Kindle®, however, many non-dedicated-e-reader electronic devices including computers, tablets and smartphones, and other screened stationary and mobile devices can also be used to read e-books.

Throughout this disclosure, terms used herein to describe or reference media holding software, including without limitation terms such as “media,” “storage media,” and “memory,” may include or exclude transitory media such as signals and carrier waves.

Throughout this disclosure, the term “browser extension” means a software component which is installable in a web browser to extend or expand the Functionality of the browser. Also sometimes called “plug-ins,” browser extensions are generally inoperable outside of the web browser, and rely on or require the web browser to function.

Throughout this disclosure, the term “cloud” and “cloud computing” and similar terms refers to the practice of using a network of remote servers hosted and accessed over the Internet to store, manage, and process data, rather than local servers or personal computers.

Throughout this disclosure, the terms “user” and “learner” are generally interchangeable and refer to a person using the systems, methods, and devices described herein to learn a second language.

Throughout this disclosure, the term “base language” means a language that a user already understands, The base language will usually be a first-acquisition language acquired during infancy or childhood, but may also be an additional language already acquired by the user in youth or adulthood.

Throughout this disclosure, the term “second language” means a non-base language that a user desires to acquire or learn. Although the ordinal qualifier “second” is used, it will be understood that this is a term of art to refer to acquisition of any languages (whether a second, third, fourth, etc.) other than a first language. The term “target language” may also be used herein, and has the same meaning as “second language.”

The examples provided herein are illustrative and non-limiting. English is generally used herein as the exemplary base language, and Spanish is generally used as the exemplary second language, but these are illustrative examples only, and the systems, methods, and devices described herein may use any base language and any second language, regardless of typography. For example, the base language could be Russian and the second language could be Korean.

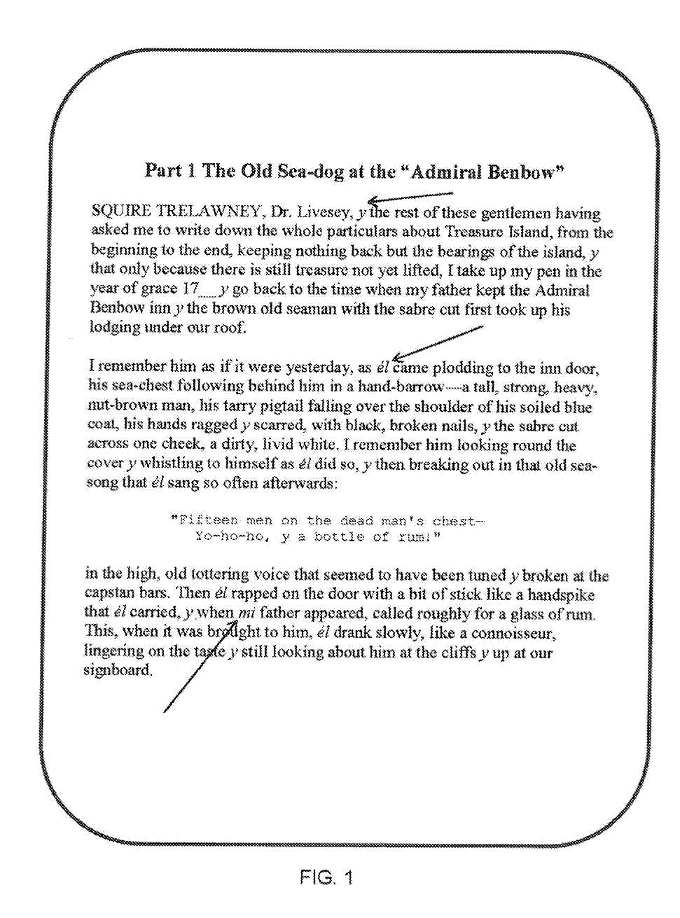

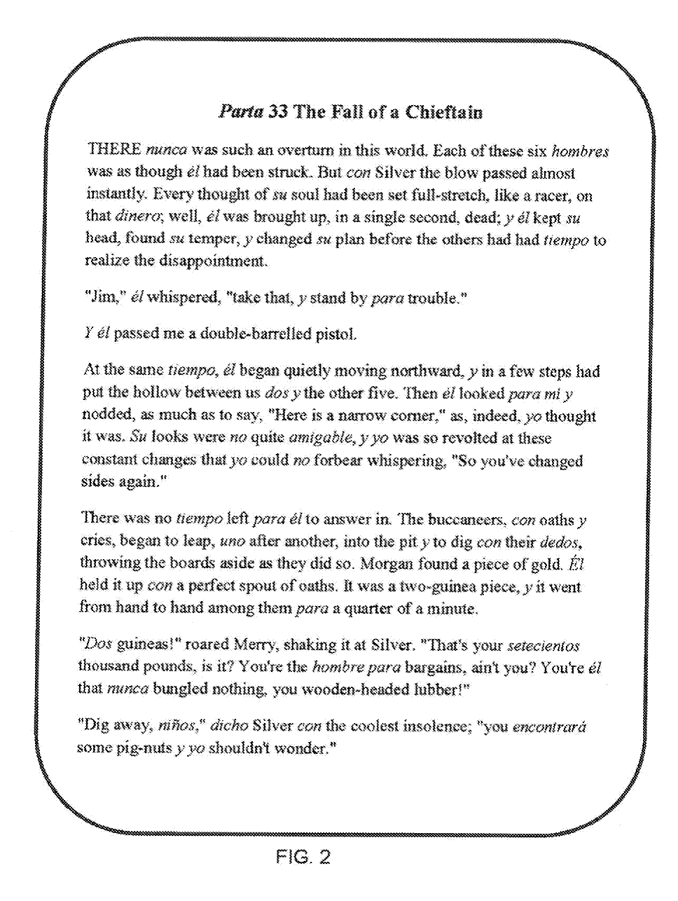

In the depicted embodiment of FIGS. 1-2, the embodiment is that of a physical book. The physical book slowly, but preferably substantially steadily, increases the amount of distinct target language words presented on a given page or a given 100-word sample in a book, for example, one new target language word per one hundred words text. As shown in FIGS. 1 and 2, a book such as Treasure Island could start the first chapter slowly introducing one new target word after another and end the first chapter with, for example five percent of the words in the target language and ninety-five percent of the words in the base language or a translation ratio of five percent. By the last chapter, for example, twenty-five percent of the words could be in the target language and seventy-five percent in the base language, or a translation ratio of twenty-five percent. The translation ratio can be understood as the ratio of target language words to total words in a given sample or chapter of text. Though Spanish is used throughout this disclosure as a target language and English is used as base language, it is understood that basically any language may be used as the target language and as the base language.

As another example of the first embodiment, the novel The Girl with the Dragon Tattoo's first chapter could start with a translation ratio of five percent and end the book with a translation ratio of twenty percent. Though these two books are novels, other embodiments could include non-novel books, but longer form stories are preferred. Fiction and non-fiction stories would provide the reader motivation to continue reading and continue being exposed to the new target language words because they will want to continue to see how the story unfolds. The extended nature of novels also confers surprising learning benefit in that the reader is self-motivated to read 200 to 300 pages or more, for example, or 50,000 W 150,000 words because of the quality of the story and independent of any well of academic self-discipline. Thus, with the novel or extended story, the reader/learner is exposed to and acquires potentially thousands of target language words per novel, with the effect being a gradual, consistent, and largely unnoticed emersion of the learner in the target language. This is distinctly different from the drudgery experienced by the traditional language learner trying to rotely memorize even as handful of target language words to little effect or slogging through translating entire blocks of target language words, with much effort and little gain.

A variation of the single contained story embodiment is to use books that are part of a series. Using hooks from a series will engage the learners in the overarching story and provide motivation to keep reading one book after the next. For example, The Girl with the Dragon Tattoo book has a number of sequels, the first sequel being The Girl Who Played with Fire. In series books, such as the “The Girl . . . ” series, the ratio of translation could overlap, thereby allowing the learner to reaffirm the learner's learning over the course of a series of books. In one version of this variation, the second book of a series, such as The Girl Who Played with Fire, could start off with a five percent lower translation ratio than the immediately previous book of the series, here the The Girl with the Dragon Tattoo.

In such an embodiment, for example, The Girl Who Played with Fire could start of with fifteen percent of the words in the target language and eighty-five percent of the words in the base language, where the The Girl with the Dragon Tattoo in this embodiment ended with twenty percent of the words in the target language and eighty present in the base language. After the initial ratio of translation, The Girl Who Played with Fire would steadily introduce new target language words and end at, for example, thirty percent of the words in the target language and seventy percent of the words in the base language.

Alternatively, the second book could have an equal initial translation ratio as the first book's ending translation ratio, picking up right where the first book left off, as going backward in initial translation ratio may put off some learners. Additionally, the second book could have a higher initial translation ratio, if, for example, the learner had utilized other acquisition devices or methods after finishing the first book and before beginning the second book. Also, the second book's initial translation ratio could start lower than the ending translation ratio of the first book, but the rate of target language word introduction in the second book could initially be higher than, for example, the ending rate in the first book, and then taper of to a lower rate when the second book's translation ratio reached the first book's ending translation ratio. For example, the last chapter of the first book could have an average new target language word introduction rate of one new target language word per thousand words and a translation ratio of twenty percent.

Books could also be ranked from beginner to expert, with multiple subcategories possible, each level having its own starting translation percentage, level of transition, and difficulty of vocabulary. Transition referring to the change from the base language to the target language. Target language words will preferably be demarked in some fashion, such as in italics as shown in FIGS. 1 and 2, to inform the learner that these are translations from the learner's primary language. Further context may be provided in a footnotes format, while lull definitions would preferably be provided in an end of chapter or end of the book appendix. The further context may include a base language definition of the target language word, an image, or the target language word used in a context the learner would find easily recognizable—for example “One, two, tres, four . . . ;” “Roses are red, violets are azul” or “Rusty put his cowboy sombrero on his head and got on his horse.”

Common genres of fiction that the second language acquisition device may take the form of include, for example: Comic/Graphic Novels—scripted fiction told visually in artist drawn pictures, usually in panels and speech bubbles; Crime/Detective Fiction; Fairy tales; Fantasy; Fiction narrative; Fiction in verse; Folklore; Historical fiction; Horror; Humor; Legend; Magical Realism; Metafiction; Mystery; Mythology; Mythopoeia; Realistic fiction; Science fiction; Suspense/Thriller; Tall tale; and Western. Common genres of nonfiction that the second language acquisition device may take the form of include, for example: Biography/Autobiography; Narrative nonfiction; and Long Speeches—public address or discourse 20,000 words or longer. Books can be all text, text and illustrations, or graphic/comic novels.

Although essays—a short literary composition that reflects the author's outlook or point, short speeches—public address or discourse under 20,000 words, and Short stories—a work of fiction usually no shorter than 1,000 words and no longer than 20,000 words (collectively short works), may also be part of the second language acquisition device, it is preferred to have longer stories or works. Short works that are part of a collection, preferably involving common characters, storyline, or theme, could be advantageously used together though and the translation ratio, rate, and acquired words could be seamlessly integrated, one short story to the next, to in effect create a novel's worth of words and learning in the group of short works. For example, the translation ratio at the beginning of the first short work (a short story for example) in a collection could be five percent and at the end could be seven percent. The translation ratio at the beginning of the second short work (an essay for example) could be seven percent and at the end could be ten percent. And on and on until the last short work of the collection (a short speech, for example), in which the translation ratio at the beginning could be twenty-two percent and the end could be twenty-five percent. The target language words acquired at some point in any of the short works would preferably be considered acquired in any subsequent short works of the collection. For example, a word considered acquired in the 1335th word of the third short work would preferably still be considered acquired in the 1st word of the fourth short work and any subsequent short work of the collection. The effect is a slow and steady and almost inconspicuous emersion of the learner in the target language.

According to further variation, target language words may be introduced in the text or audio of the story in a sentence directly following the same word being used in the base language—especially if the target language word is introduced in a similar phrasing as used in a directly preceding sentence. For example, similar to FIG. 2, “ . . . It was a two-guinea piece, and it went from hand to hand among them with a quarter of a minute. “Dos guineas!” roared Merry, shaking it at Silver . . . ” Such an introduction increases the likelihood of the learner understanding, of the meaning of target language word without having to refer to something outside of the story, especially when the context of the introduced target language word would otherwise not necessarily be clear.

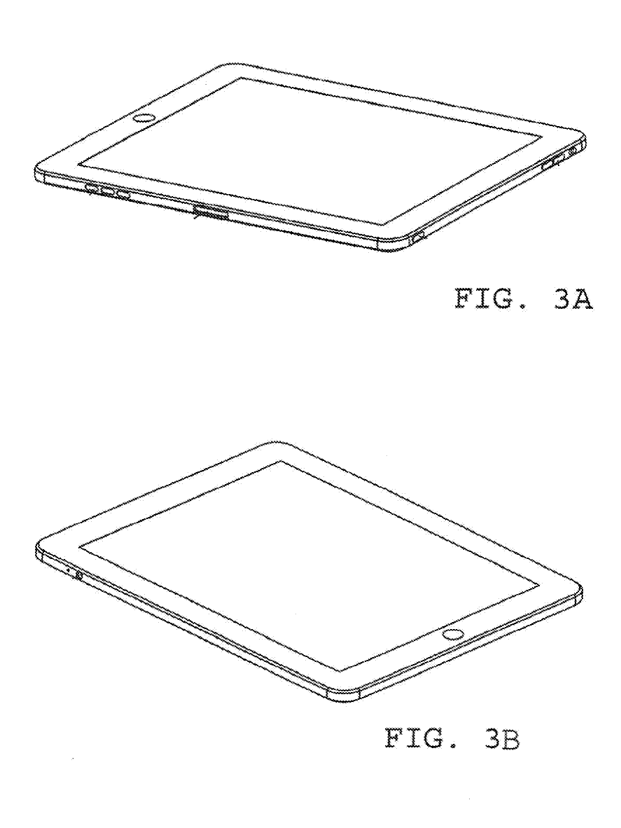

In the depicted embodiment of FIG. 3A and. 3B, the embodiment is that of an e-Book or similar computer device. In such an embodiment, the language acquisition systems and methods are implemented via a stored program in a memory, executed on a computer processor.

For the e-book embodiment of the second language acquisition device and method, in a first variation the e-book can contain the same text and translations as the hard copy book embodiment above. In a second variation, a computer program may convert any e-book into a second language acquisition element, translating words at a set rate from a starting translation ratio at the beginning of the e-book to an ending translation ratio at the end of the e-book, which may vary based on the input of the learner.

Additionally, in this embodiment the program will allow for interaction with the learner by giving the learner the ability, among other things, to confirm that the learner understands a particular target language word or not. If the learner does not, the learner can click on the unfamiliar word and inform the program that the learner does not know the unknown word. The program can then give the learner, in a pop up box or in the margin for example, some form of hint or cue as to the meaning of the unfamiliar word. The program can display the unfamiliar word in one or more different context cues, show one or more picture or video cues, give one or more a sound cues, and/or display a base language translation of the unfamiliar word.

The context cues include both general and personal contextual cues. General contextual cues include base language definitions of the unfamiliar word, the unfamiliar target language word used in idioms or other common phrases in the base language (e.g., “Don't put all your huevos in one basket”, or “It's raining cats and perros outsider!”), or the unfamiliar target language word is used in context that clearly indicates the meaning (e.g., On the moonless night the sky was pitch negro,” or “John will sentarse down in the chair to rest”). If the electronic device running the program has a calendar and clock, the time, date, month, year, and season. For example, may be integrated in the contextual cues.

For personalized contextual cues, the cues with have special significance to the specific learner or individuals in a same demographic as the learner (age, sex, geography, occupation, etc.). For one embodiment, the program may present the learner with a questionnaire for the learner to complete, preferably prior to the learner reading the e-book. For example, a learner may be asked what the name of the learner's dog is, which is perhaps Butch. Then, for example, if the learner indicates that the learner does not know what the target word for ‘dog’ means, the contextual cue could be “Butch is one of these,” or something similar. For demographic context, the program may allow the learner to enter demographic information and then the contextual cues may use references that would likely be familiar to members of the given demographic. For example, for men born before 1950, if the learner indicates that the learner does not know what the target word for ‘dog’ means, the contextual cue presented could be “Rin Tin Tin was one of these.”

In a further embodiment of personalized contextual cues, the program can link and access data from the learner's social media account or other remote accounts, or personalized data on a common local network, server, or machine as the device running the program. The program can then contextualize vocabulary based off of personal learner information without requiring the learner to enter it into the program. For example, the learner's birthday—January 15—and hair color—black—may be stored on the learner's Facebook account. In this embodiment, the program could access the learner's Facebook account and populate values in a program memory based on learner data found in the Facebook account. In this embodiment, if it is currently January 1 when the learner is using the program, the program may state “Your birthday is in dos weeks,” or “Your hair is negro”.

The cue may also be a picture of video that Shows, for example, the thing, action, or quality that is embodied in the unfamiliar word. For example, if the unfamiliar target language word means “dog,” the visual cue could be a picture or a video of a Golden Retriever dog. For visual cues, the image could be shown for an extended time or can be flashed for a single duration flash in a substantially subliminal range lasting, 4, 18, 25, or 50 milliseconds, or can be multiple flashes each of a same subliminal duration or of increasing subliminal duration, with the number and/or duration of flashes preferably increasing with the number of times the word is tapped. Subliminal is preferable as the learner becomes aware of the base language translation of the unfamiliar target word without consciously seeing the image itself.

The sound cue can take a number of embodiments. It can be the audible pronunciation of the unfamiliar target language word in the target language. The sound cue can be a sound associated with the unfamiliar word (e.g., the sound of a cow mooing for the word “cow,” or the sound of moderate timed footsteps for the word “walk”). The sound cue can also be combined with text, such as the program displaying the words “a makes this sound” and then the program causing the device to make the sound of a cat's meow. The sound cue could be combined with both text and a visual cue at the same or substantially the time also. One example is the program displaying the words “a makes this sound,” while the program shows or flashes as picture of a cat and the program additionally causes the device to make the sound of as cat's meow.

The display of the base language translation can be shown for an extended time or can be flashed for a single duration flash in a substantially subliminal range lasting 4, 18. 25, or 50 milliseconds, or can be multiple flashes each of a same subliminal duration or of increasing subliminal duration, with the number and/or duration of flashes preferably increasing with the number of times the word is tapped. Subliminal is preferable as the learner becomes aware of the base language translation of the unfamiliar target word without consciously seeing or hearing the base language word. Additionally, the flash can just be very short, on the order of 100 to 200 milliseconds. Because optimal second language acquisition and usage is achieved when the learner associates the target language word directly with the meaning of the word and not the base language translation of the word, other cues are preferably used before the flash of the base language translation.

The type, duration, and amount of cues can change based on, for example, the number of times the unfamiliar word has been shown so far in the target language, the number of times the learner has tapped the specific unfamiliar word, the number of words the learner has read since last encountering the specific unfamiliar word in the target language, and the number of times the specific unfamiliar word has been presented in the target language where the learner has not tapped the word.

The learner user will preferably pass through several iterations of different cues before the learner is given the definition and/or pronunciation of the word. The rate introducing new target language words will be slowed if the learner repeatedly indicates that they are not learning the new vocabulary. If no feedback is given the program may assume the reader knows the word and will continue with the rate of transition. The rate of transition referring to the rate of change from the base language to the target language, also called the rate of new target language word introduction.

Additionally, the e-book embodiment may utilize the computer devices with a forward facing camera to track the learner's eye movement while the learner is reading the text. The learner's eye movement could then be used to calculate how much each target language word is slowing the reader, if at all. As the learner reencounters a target language word, the program can compare how much the learner slows compared to previous encounters with this word. This information will allow the program to alter the rate new target word introduction transition, so the learner neither becomes overwhelmed nor becomes bored with a too slow rate of introduction of target language words. The program preferably attempts to keep the learner's reading rate and the transition to the target language in balance.

Additionally, learner time spent per page (taking into account a number and complexity of words on page) or words per minute may be recorded and calculated by the program. Advantageously, the program will also have calculated a baseline reading rate (words per minute for example) of the learner in the learner's primary or base language. As the learner is reading through the story, the program will preferably compare a learner's contemporaneous reading rate with the learner's baseline reading rate to judge engagement, frustration, and satisfaction of the learner with the secondary language acquisition process. This comparison could also be made with calculating the rate at which the reader turns the page on the e-book device, based on the number of words on the page or an average number of words on a page. This could further provide the learner with a customizable experience. The learner could additionally select what percentage of the learner's baseline reading rate the learner is willing to sacrifice for a higher rate of new target language word introduction.

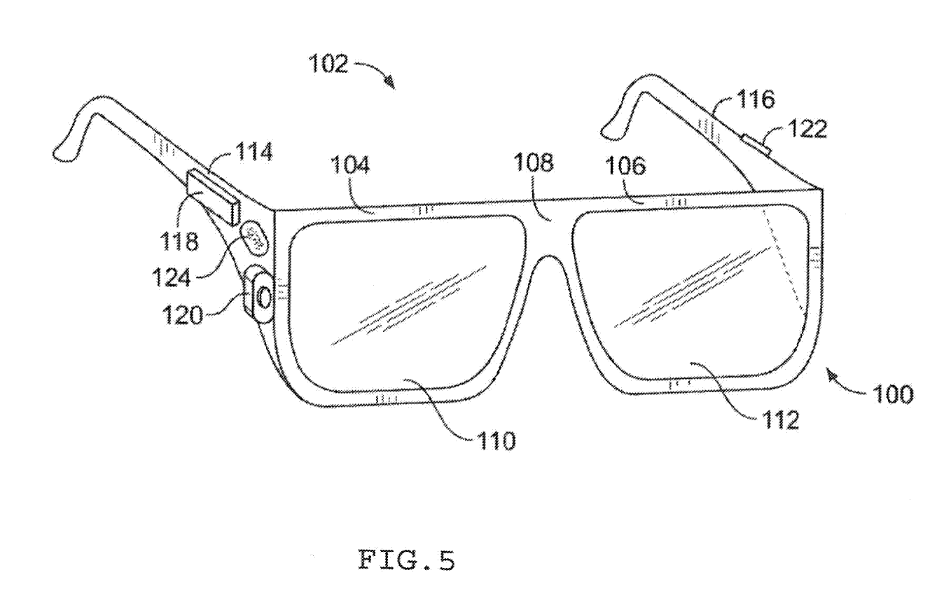

In the depicted embodiments of FIGS. 5-8, the embodiment is a wearable computing device. As wearable, optical computing devices, such as the Apple® Watch and Google Glass®, become more prevalent, they will provide users with readily available displays, such as a heads-up display (HUD), that can provide information to the users. Such displays may provide in-line video for the learner.

FIG. 5 illustrates an example system 100 for receiving, transmitting, and displaying data in the form of a wearable computing device. While FIG. 5 illustrates a head-mounted device 102 as an example of a wearable computing device, other types of wearable computing devices could additionally or alternatively be used. As illustrated in FIG. 5, the head- mounted device 102 comprises frame elements including lens frames 104, 106 and a center frame support 108, lens elements 110, 112, and extending side-arms 114, 116. The center frame support 108 and the extending side-arms 114, 116 are configured to secure the head-mounted device 102 to as user's face via a user's nose and ears, respectively.

Each of the frame elements 104, 106, and 108 and the extending, side-arms 114, 116 may be formed of a solid structure of plastic and/or metal, or may be funned of a hollow structure of similar material so as to allow wiring and component interconnects to be internally routed through the head-mounted device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the head-mounted device 102 to the user. The extending side-arms 114, 116 may further secure the head-mounted device 102 to the user by extending around a rear portion of the user's head. Additionally or alternatively, for example, the system 100 may connect to or be affixed within a head-mourned helmet structure, Other possibilities exist as well.

The system 100 may also include an on-board computing system 118, a video camera 120, a sensor 122, and a finger-operable touch pad 124. The on-board computing system 118 is shown to be positioned on the extending side-arm 114 of the head-mounted device 102. However, the on-board computing system 118 may be provided on other parts of the bead-mounted device 102 or may be positioned remote from the head-mounted device 102 (e.g., the on-board computing system 118 could be wire- or wirelessly-connected to the head-mounted device 102). The on-board computing system 118 may include a processor and memory, for example. The on-board computing system 118 may be configured to receive and analyze data from the video camera 120 and the finger-operable touch pad 124 (and possibly from other sensory devices, user interlaces, or both) and generate images for output by the lens elements 110 and 112.

The video camera 120 is shown positioned on the extending side-arm 114 of the head-mounted device 102. However, the video camera 120 may be provided on other parts of the head-mounted device 102. The video camera 129 may be configured to capture images at various resolutions or at different frame rates. Many video cameras with a small form-factor, such as those used in cell phones or webcams, for example, may be incorporated into an example of the system 100.

Further, although FIG. 5 illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality Acre computer generated images appear to interact with the real-world view perceived by the user.

The sensor 122 is shown on the extending side-arm 116 of the head-mounted device 102. However, the sensor 122 may be positioned on other parts of the ‘head-mounted device 102. The sensor 122 may include one or more of a gyroscope or an accelerometer, for example. Other sensing devices may be included within, or in addition to, the sensor 122 or other sensing functions may be performed by the sensor 122.

The linger-operable touch pad 124 is shown on the extending side-arm 114 of the head-mounted device 102. However, the finger-operable touch pad 124 may be positioned on other parts of the head-mounted device 102. Also, more than one finger-operable touch pad may be present on the head-mounted device 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities.

The finger-operable touch pad 124 may be capable of sensing finger movement in a direction parallel or planar to the pad surface, in a direction normal to the pad surface, or both, and may also be capable of sensing a level of pressure applied to the pad surface. The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one ringer-operable touch pad is present, each finger-operable touch pad may be operated independently, and may provide a different function.

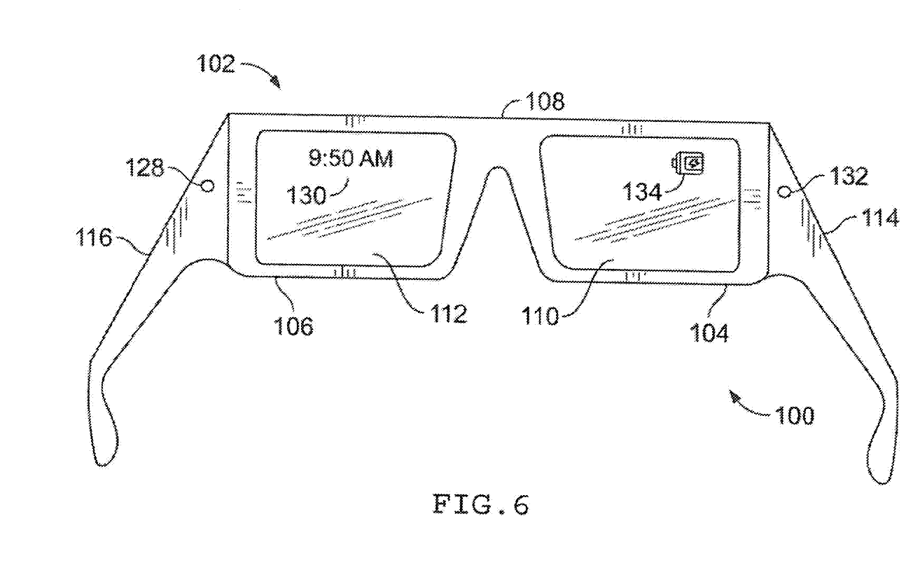

FIG. 6 illustrates an alternate view of the system 100 illustrated in FIG. 5. As shown in FIG. 6, the lens elements 110, 112 may act as display elements. The head-mounted device 102 may include a first projector 128 coupled to an inside surface of the extending side-arm 116 and configured to project a display 130 into an inside surface of the lens element 112. Additionally or alternatively, a second projector 132 may be coupled to an inside surface of the extending side arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the users eyes, or other optical elements capable of delivering an in focus near-to-eye image to the user. A corresponding display driver may be disposed within the frame elements 104, 106 for driving such a matrix display. Alternatively, or additionally, a laser or LED source and scanning system could be used to draw a raster display directly onto the retina of one or more of the user's eyes. Other possibilities exist as well.

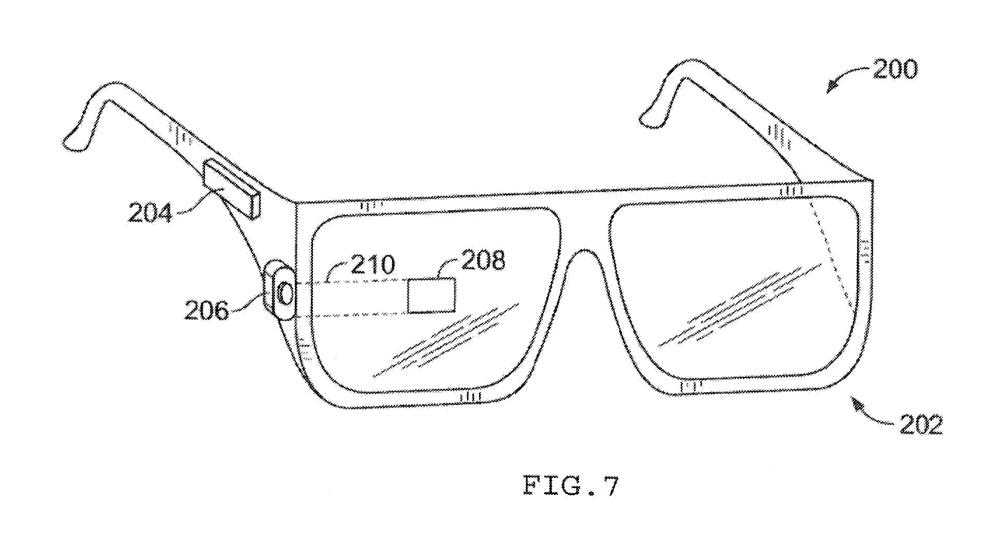

FIG. 7 illustrates an example system 200 for receiving, transmitting, and displaying data. The system 200 is shown in the form of a wearable computing device 202. The wearable computing device 202 may include frame elements and side-arms such as those described with respect to FIGS. 5-6, The wearable computing device 202 may additionally include an onboard computing system 204 and a video camera 206, such as those described with respect to FIGS. 5-6. The video camera 206 is shown mounted on a frame of the wearable computing, device 202; however, the video camera 206 may be mounted at other positions as well.

As shown in FIG. 7, the wearable computing device 202 may include a single display 208 which may be coupled to the device. The display 208 may be formed on one of the lens elements of the. wearable computing device 202, such as a lens element described with respect to FIGS. 5-6, and may be configured to overlay computer-generated graphics in the user's view of the physical world. The display 208 is shown to be provided in a center of a lens of the wearable computing device 202, however, the display 208 may be provided in other positions. The display 208 is controllable via the computing system 204 that is coupled to the display 208 via an optical waveguide 219.

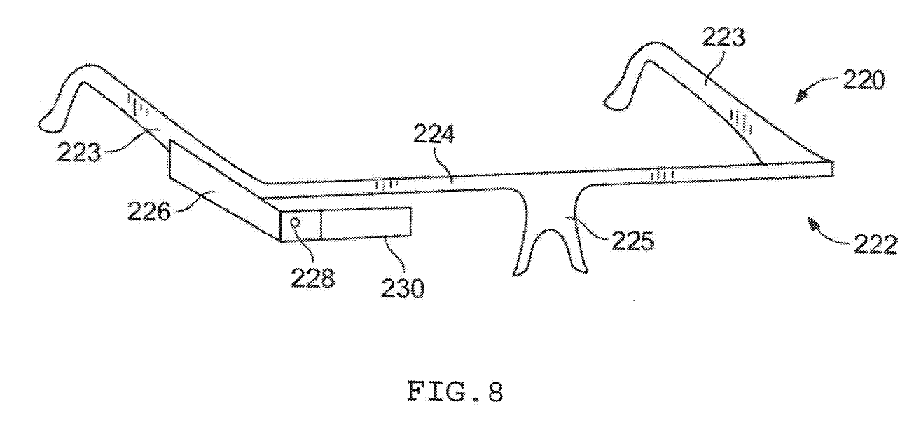

FIG. 8 illustrates an example system 229 for receiving, transmitting, and displaying data. The system 220 is shown in the form of a wearable computing device 222. The wearable computing device 222 may include side-arms 223, a center frame support 224, and a bridge portion with nosepiece 225. In the example shown in FIG. 8, the center frame support 224 connects the side-arms 223. The wearable computing device 222 does not include tens-frames containing lens elements. The wearable computing device 222 may additionally include an onboard computing system 226 and a video camera 228, such as those described with respect to FIGS. 5-6.

The wearable computing device 222 may include a single lens element 230 that may be coupled to one of the side-arms 223 or the center frame support 224. The lens element 230 may include a display such as the display described with reference to FIGS. 5-6, and may be configured to overlay computer-generated graphics upon the user's view of the physical world. In one example, the single lens element 230 may be coupled to the inner side (the side exposed to a portion of a user's head when worn by the user) of the extending side-arm 223. The single lens element 230 may be positioned in front of or proximate to a user's eye when the wearable computing device 222 is worn by a user. For example, the single lens element 230 may be positioned below the center frame support 224, as shown in FIG. 8.

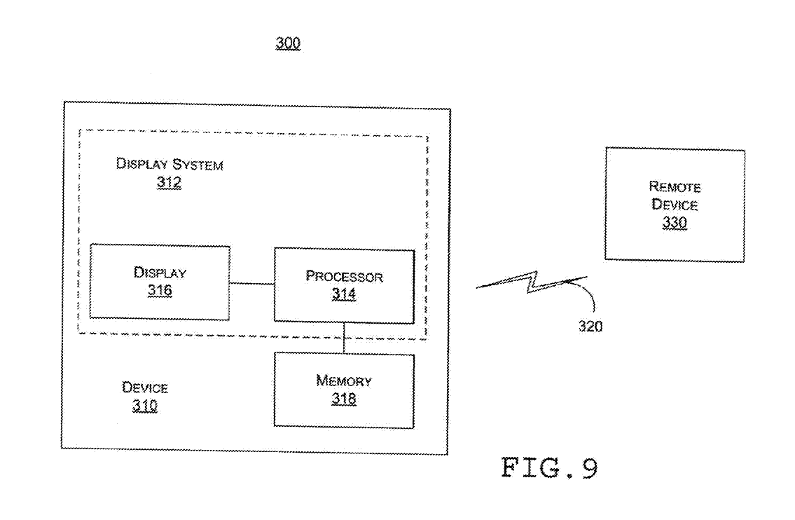

FIG. 9 illustrates a schematic drawing of an example computing system 300 for use with aspects of the disclosure. In the system 300, a device 310 communicates using a communication link 320 (e.g., a wired or wireless connection) to a remote device 330. The device 310 may be any type of device that can receive data and display information corresponding to or associated with the data. For example, the device 310 may be a heads-up display system, such as the head-mounted device 102, 200, or 229 described with reference to FIGS. 5-6.

Thus, the device 310 may include a display system 312 comprising a processor 314 and a display 316. The display 310 may be, for example, an optical sec-through display, an optical see-around display, or a video see-through display. The processor 314 may receive data from the remote device 330, and configure the data for display on the display 316. The processor 314 may be any type of processor, such as a micro-processor or a digital signal processor, for example. The device 310 may further include on-board data storage, such as memory 318 coupled to the processor 314. The memory 318 may store software that can be accessed and executed by the processor 314, for example.

The remote device 330 may be any type of computing device or transmitter including a laptop computer, a mobile telephone, or tablet computing device, etc., that is configured to transmit data to the device 310. The remote device 330 and the device 310 may contain hardware to enable the communication link 320, such as processors, transmitters, receivers, antennas, etc.

In FIG. 9, the communication link 320 is illustrated as a wireless connection. However, wired (e.g., tethered) connections may also be used. For example, the communication link 320 may be a wired serial bus such as a universal serial bus or a parallel bus. A wired connection may be a proprietary connection as well. The communication link 320 may also be a wireless connection using, e.g., Bluetooth® radio technology, communication protocols described in IEEE 802.11 (including any IEEE 802.11 revisions), Cellular technology (such as GSM, CDMA, UMTS, EVDO, WiMAX, or LTE), or Zigbee® technology, among other possibilities. The remote device 330 may be accessible via the Internet and may include a computing cluster associated with a particular web service (e.g., social-networking, photo sharing, address book, etc.).

These mobile computing devices could become second language acquisition devices, especially such devices with HUD. In addition to the language transition programing above, the program would have an additional visual language translation capacity. When looking around his environment, the learner may look at a street sign and the program could translate the sign. These translated words will be displayed and demarked in sonic way to inform the learner that the program has been applied to that word. The learner could then provide feedback to the program that the learner is familiar with the target language word or not familiar with the target language word. If not familiar with the target language word, the program could provide a definition, pronunciation, and/or a cue as to the meaning of the word.

In an embodiment, the language substitution technique described herein may be implemented in the context of web sites or other digital documents the user reads during day-to-day life. For web sites, for example, the systems and methods use computer technology to cause the displayed web site to substitute certain words from the user's base language to the target language. Thus, as the user reads web sites the user encounters words in the target language. Because the web sites are, generally, topics of interest to the user, the context in which the target language terms appear is likely to be more obvious to the user than in scenarios typically found in academic and other second language acquisition materials.

This technique may be used in conjunction with other documents, such as word processing documents, e-mails, text messages, and social networking content. Essentially, any text content displayed to the user can be partially or fully translated according to the systems and methods described herein. To the extent that the displayed text is not in a text format (such as ASCII), optical character recognition technologies, known in the art, may be used to convert such content to a text format.

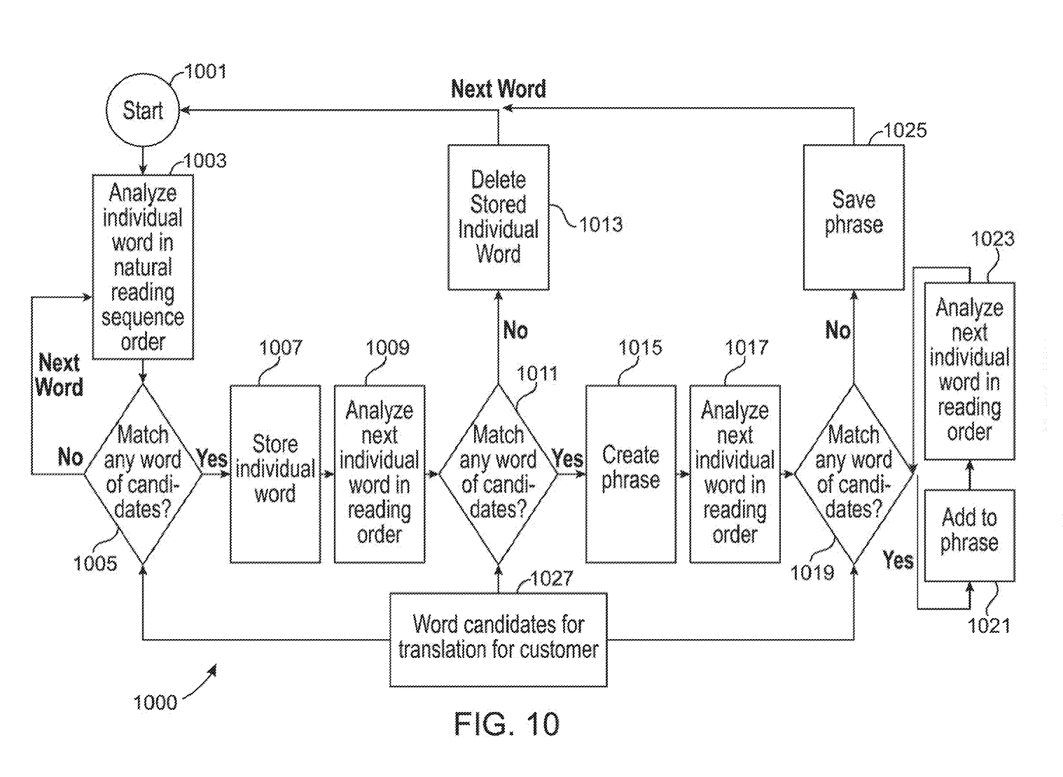

FIGS. 10-13 depict computer systems and method for implementing these techniques. The depicted computer implemented methods generally use software on the user's client computer device to examine the text content of a digital document, identify individual words that appear in that document in the user's base language, provide that list of words to a remote computer, and receive back from the remote computer a list of words in the based language to be translated, and the target language terms to which those words will be translated. Additionally, in certain embodiments, the client software may also provide to the server system a count of how many times each word in the base language appears in the source document. This count may be used by the server, as described in more detail elsewhere herein, as a factor in determining which words will be translated.

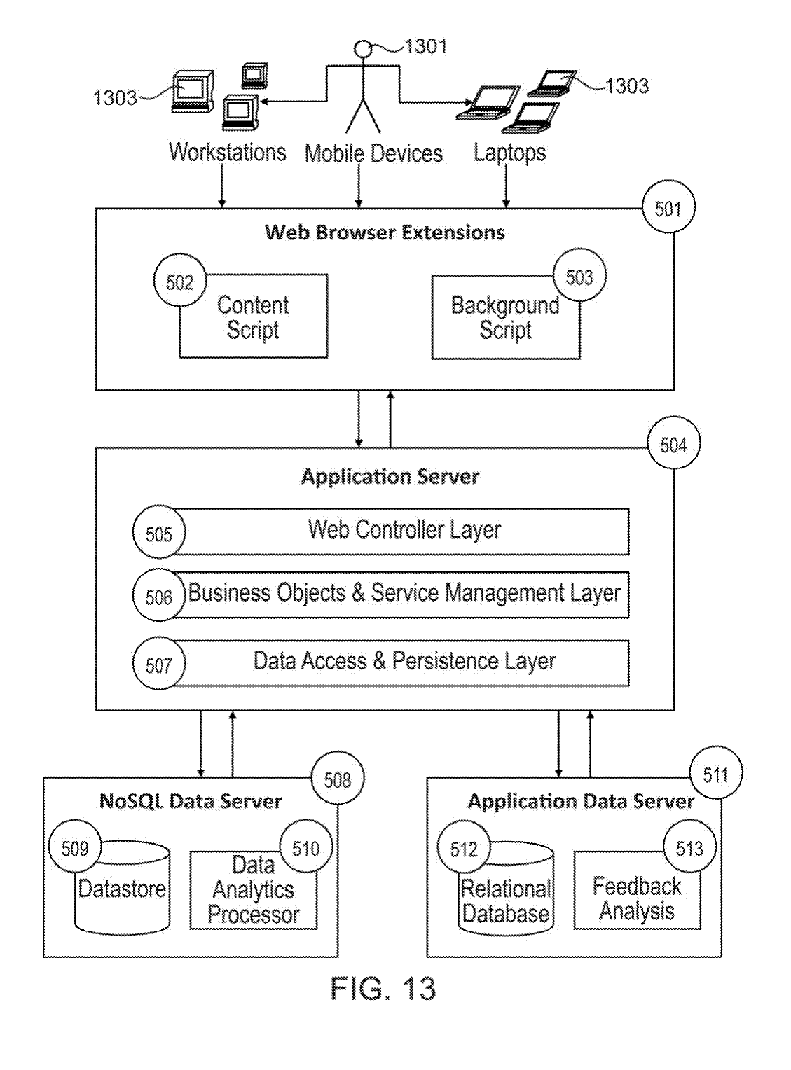

FIG. 13 depicts a high-level embodiment of a computerized system implementing the methods described, herein. In the depicted embodiment of FIG. 13, a user 1301 of a client computer device 1303, browsing a website with a browser or other user-agent on the client computer 1303, connects to a remote application server 504. This connection is generally over the internet or a similar type of telecommunication network. In the depicted embodiment, this connection is established by one or more browser extensions. The browser extensions 501 may comprise a content script 502, which examines the content of a web page (in the base language) viewed by the user 1301, to identify and collect words appearing in the base language on the page, and, optionally, the number of times each word appears. The depicted background script 503 communicates with the application server 504 and various software modules thereon, such as but not limited to, a web controller 505, to implement the methods described herein. These software modules of the application server 504 are described in more detail elsewhere herein. The content script 502 uses responses received from the application server 504 to update the content of the displayed web page with the substitutions as described elsewhere herein.

In the depicted embodiment of FIG. 13, the system further comprises persistent data storage 508, typically a database. Although a NoSQL Data Server 508 is depicted, any database is suitable, including relational and SQL-based databases. In the depicted embodiment, the database 509 is on a separate server 508, having its own processor 510, but, as described elsewhere herein, the database 509 could be implemented on the same server 504 as the server software modules. The application data server 511 (also sometimes referred to as at feedback server) stores sets of data used to operate the systems and methods in general. Such data includes, but is not necessarily limited to, user registration information, user profile information., payment information, language translation and parts-of-speech tagging information, and feedback submitted by users. The application data server 511 generally uses this data for analytics on the user feedback in order to determine usage trends and to help provide inputs as well as directions for further product development that will be more beneficial and enjoyable for the users in terms of effortless language learning.

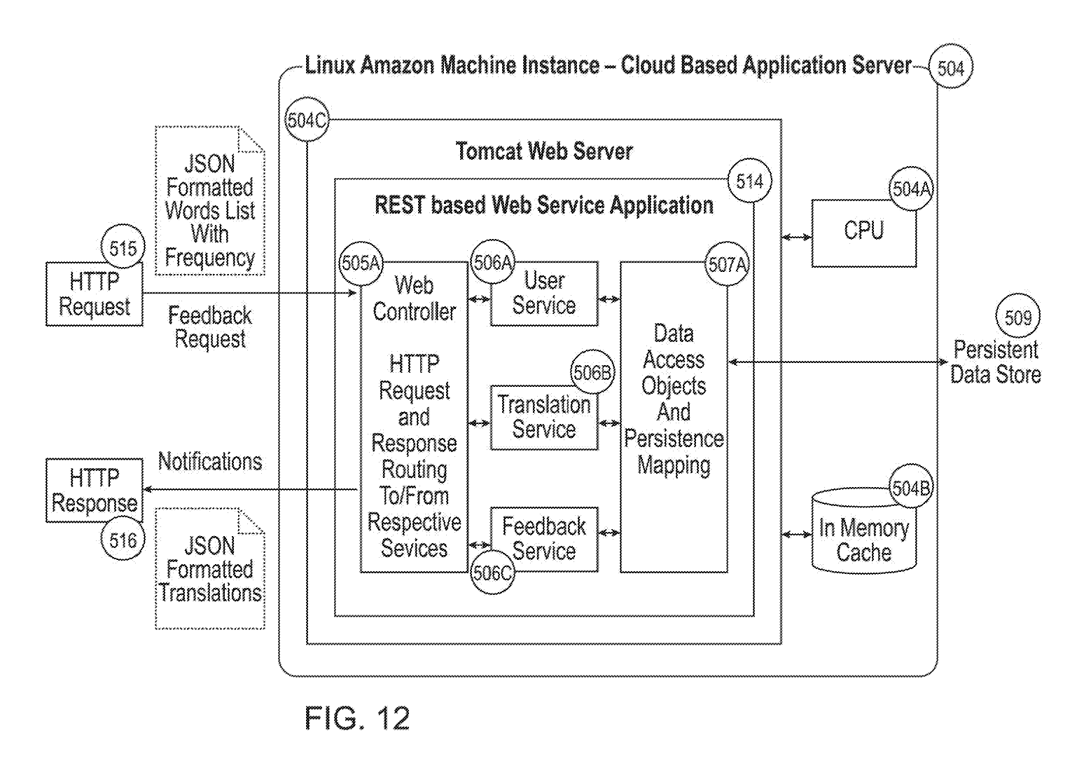

FIG. 12 depicts the application server 504 and other server-side aspects in further detail. In the depicted embodiment of FIG. 12, the application server 504 comprises a processor 504A, memory 504D, and web server 504C. The depicted web server 504C farther comprises a web services application 514, which in turn comprises a web controller 505A, user service 506A, translation service 506B, and data access and persistence mapping software 507A. In the depicted embodiment, the web server 504C is a Tomcat server, but any sufficiently functional web server implementation may be used. In the depicted embodiment, the application server 504, is a cloud platform, such as Amazon® Web Services or another such cloud computing service 504. However, in an alternative embodiment, the application server 504 may be a local installation, or collocation at an appropriate service provider. The depicted software is executed by processing, unit. 504A of the application server 504, and data may be managed via an in-memory cache 504B of the application server 504. A persistent data store 509 may be maintained externally to the application server 504, and may further be external to the application server itself, as shown in FIG. 13. The depicted embodiment further includes as feedback service 506C.

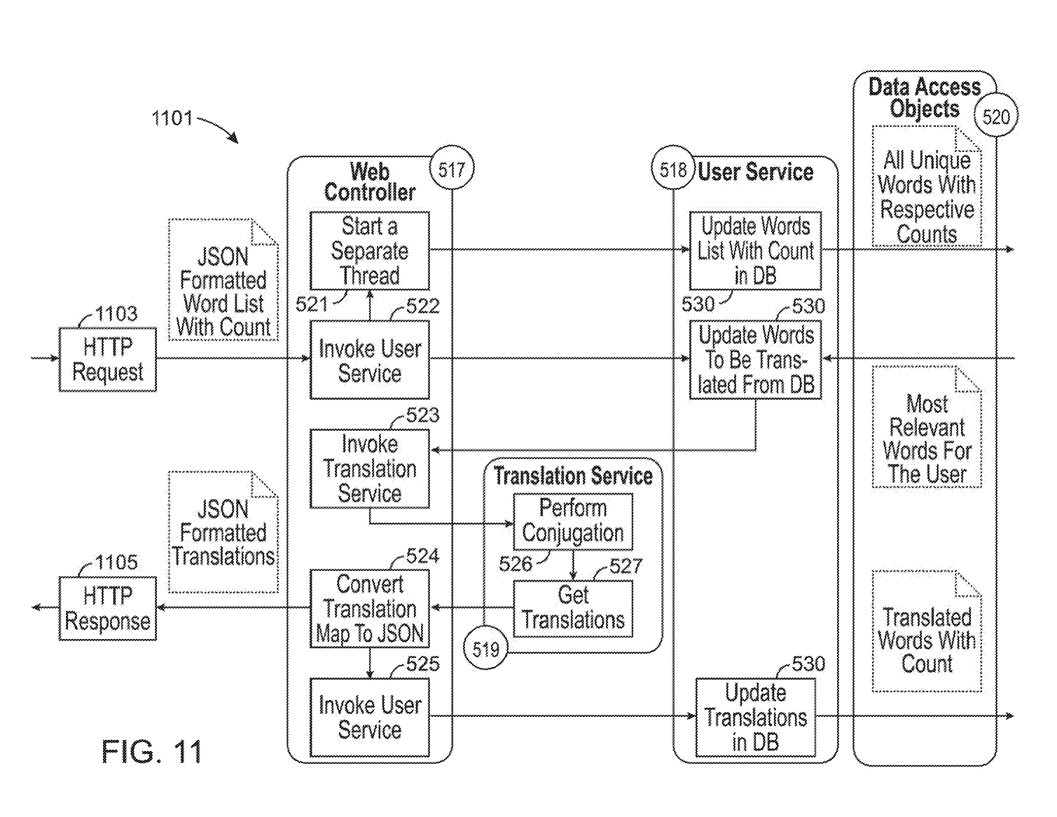

FIG. 11 depicts a more detailed illustration of data flow among some component systems. In the depicted embodiment of FIG. 11, a client request 1103 is received by the web controller 517, usually from a web extension 501. This may be via the web server 504C, which is communicatively coupled to the web controller 517, or the web controller 517 may be a module or add-on built into the web server 504C. The client request 1103 includes the list of words in the base language (and possibly a count of the number of terms each word appears in the original base language text, as described elsewhere herein), typically in a standard data exchange format, such as XML or JSON. It will be appreciated by one of ordinary skill in the art that, although most lay users understand web clients to be browsers, and web servers to be web sites, the HTTP protocol can, and often is, used as a data exchange protocol in contexts outside the traditional browser. In the depicted embodiments, the request 1103 may originate from as browser, or may originate from a non-browser based client programmed to communicate using HTTP. Typically, however, the request will have elements of both, in that the request may be generated by a browser extension 501.

The web controller 517 then invokes the user service 518 to determine which words in the request 1103 should to be translated 529. The user service 518 is also generally a computer software module, which may also communicate using HTTP, or using another protocol, which may be a known or proprietary protocol. The modules may communicate using interprocess communications techniques known in the art.

The user service 518 then communicates with the data store 509 via data access objects 520 and determines which of the base language words received in the request 1103 should be translated to the second language. As described elsewhere herein, this determination may be based on a number of factors, with the general goal of translating both those terms the user has already mastered, and new terms in the process of being learned which will further challenge the user learning and advance the second language acquisition. This may be done, for example, by tracking in the database 520 which base language words have already been translated for the user and/or how many times they have been translated, and which words appear most often in texts the user is viewing, based on count data. These aspects are described in more detail elsewhere herein.

Upon determining the terms to translate, the use service 518 returns to the web controller 517 the determined words for translation. The determined words are in the base language at this stage. The translation service 519 is also generally a computer software module. The web controller 517 then provides the retrieved words 523 to a translation service 519. The translation service 519 performs conjugations 526 and translation 527 of the determined words, and returns the translated results of these operations to the web controller 517. By way of example and not limitation, the translation service 519 may use simple one-word substitutions, or may implement more complex translation techniques, such as the method depicted in FIG. 10 and described elsewhere herein. The translation service 519 may also, or alternatively, use other language translation techniques known in the art.

The web controller 517 then forms and transmits (via the web server 504C) a response 1105 to the original request 1103, by converting 524 the conjugated/translated phrases received from the translation service 519 to a format usable and/or understandable by the client 501. In the depicted embodiment, this is done using a lightweight data-exchange format, such as XML or JavaScript Object Notation, but any suitable, transmission format may be used. Preferably, the return format is the same as the receipt format. That is, if the original request 1103 formatted a word list (for translation) as JSON objects, the reply 1105 should do so also. This information san then be used by the client software 501 to substitute words in the web site displayed to the user. One of ordinary skill will appreciate that the system depicted in FIG. 11 is not limited to web sites and could also be used for any text or phrase translation, regardless of the format or structure of the original material.

Another feature is that counts may be used to identify commonly seen words. In the depicted embodiment of FIG. 11, the input request 1103 may include not only the formatted list of words for translation, but a count of the number of times each such word appears in the original text. In such cases, the web controller 517 may additionally launch a parallel routine, such as via a separate thread or process 521 to communicate to the user service 518 and provide the count data. The user service 518 may then update the database with the counts via the data access objects 520. These counts may be general, but one usually specific to a user. For example, the request 1103 may include a user identifier, and counts may be tracked and maintained in the database 520 for that user separately from all others. Thus, if the user tends to view web sites on particular subject matter (e.g., politics, technology, art), commonly used words on those sites will be more likely to receive translations due to increases in the appearance count for that specific user.

For example, the counts may be used in step 529 when the words to be translated are retrieved, in that words with high counts for the specific user may be preferred over words with low counts, causing words that appear more frequency for the specific user to be translated to the second language more often, This further facilities language acquisition in that commonly-used words are likely to be either universally present general words, such as “the” or “from,” or subject matter specific words whose meaning is easier to discern in context.

Similarly, when the translation step is completed, the web controller 517 may again invoke 525 the user service 518 to update translations in the database, showing which words have been translated for the user already. Thus, when the same base language terms appear in future uses of the system, there is sufficient data to determine both which words have already been translated for the user (and thus should continue to be translated), and which new words should be translated to further advance second language acquisition.

A s described herein, languages may differ substantially in syntax. While single-word substitutions are generally possibly as between any two languages, substituting more complex concepts may be difficult or impossible without re-structuring the text. In such cases, it is not enough to simply replace a candidate word with a literal translation, but rather a translational phrase must be provided. In a very simple example, color adjectives in English typically placed before the noun they modify, but in Spanish, they are typically placed after the noun they modify (i.e., “the White House” vs. “la Casa Blanca”).

FIG. 10 depicts an embodiment of a method 1000 for creating such translation phrases, in the depicted embodiment, a text in a base language is analyzed for opportunities to create a translational phrase. The depicted method 1000 begins 1001 by analyzing an individual word appearing in the text (in the base language) in the natural reading sequence order of the text in the base language 1003. For example, for the phrase “the very interesting book” in English, the first word in the natural reading sequence order is “the.” A comparison is made between this first word (e.g., “the”) and candidate words for translation 1027. This is typically done through a text comparison of the first word in the base language to a list of candidate words, using any number of techniques well-known in the art

If there is no matching candidate for translation, the method returns to step 1003, examining next word in the natural reading sequence of the phrase in the base language 1003. In the example of “the very interesting book,” the next word in the natural reading sequence of the phrase would be “very.”

However, if a candidate for translation 1027 is found (e.g., in Spanish, “the” translates to “el” or “la,” depending on the gender of the noun to which it refers), the individual word in the base language (e.g., “the”) is stored in a memory record 1007 and the method moves to the next step 1009, analyzing the next individual word in the natural reading sequence of the phrase in the base language 1009. in this example (“the very interesting book”), that word is “very.” The method next determines whether the next word matches any candidates for translation 1011, also using techniques welt-known in the art. If no such match is found 1013, then there is only one matching word in the base language phrase that can be translated. This is means that the substitution would be merely a simple one-word substitution, and there is no translational phrase opportunity. As such, the method would thus return to the beginning 1001 and examine the next word in the text to attempt again to identify a translation phrase, In this example, the next word would be “Interesting.”

However, if a second match is found (e.g., the English word “very” corresponds to the Spanish word “my”), there are two adjacent words in the base language that can be translated, and there is thus an opportunity to generate a translational phrase. The phrase may, depending on the base language, second language, and specific words used in the base language, be a matter of simple substitution, but this often is not known until the entire phrase is identified. If a second match is found, the second language phrase is created 1015 in a memory record. This will typically include placing the translated words into the phrase in an order appropriate to the grammatical and syntactical rules of the second language, based on the translated words determined thus far in the method. In this example, those two words are “el/la” and “muy,” and so the created phrase 1015 may comprise an indicator for “el/la” (because the corresponding noun has not yet been found) and “muy.”

Next, the method again analyzes the next individual word in the natural reading sequence of the base language 1017, in this exemplary case, finding “interesting,” and again determine whether this term matches any candidate words for translation 1019. If not, the translation phrase is completed 1025 and the substitution may or may not be performed. In this example, if the term “interesting” is not found, the substitution cannot be completed because the two words in the base language translated thus far in the phrase—“the very”—cannot be fully translated into the second language without more information. This is because Spanish articles are gender-specific depending on the noun to which they apply, but the phrase ended before a noun was identified. As such, in this example, if the phrase translation method ends with “the very,” no substitution is performed, as the substitution would simply confuse the user.

However, if a translation for the next word is found e.g., the Spanish word for “interesting” is “interesante”), the translated terms is added to the phrase that has already been created in memory 1021. As with the prior step, this may require changes in the word order due to the grammatical and syntactical rules of the secondary language. In this case, Spanish typically places an adverbial modifier before an adjective, and so no such reordering is needed at this time. Thus, the phrase now consists of “el/la muy interesante,” with the “el/la” article still incapable of being resolved due to the absence of a noun.

Next, the method again analyzes the next individual word in the natural reading sequence of the base language 1023, in this exemplary case, finding “book,” and again determine whether this term matches any candidate words for translation 1019. If not, the translation phrase is completed 1025 and the substitution may or may not be performed. In this example, if the term “book” is not found for translation, the substitution cannot be completed because the three words in the base language translated thus far in the phrase—“the very interesting”—cannot be fully translated into the second language without more information. Again, this is because Spanish articles are gender-specific depending on the noun to which they apply, and so “el/la” cannot be resolved to a specific word. In such cases, no substitution is performed to avoid confusing the user.

However, if to translation for the next word is found (e.g., the Spanish word for “book” is “libro”), the translated term is added to the phrase that has already been created in memory 1021. In this case. Spanish typically places adjective phrases after the noun they modify, whereas in English, adjective phrases appear before the noun they modify. Thus, in this instance, the term “libro” is added to the phrase 1021 by inserting it between “el/la” and “muy interesante.” Further, because the noun libro has a known gender, the article “el/la” can be resolved to “el.” Thus, the phrase in step 1021 becomes “el libro muy interesante.”

Next, the method again analyzes the next individual word in the natural reading sequence of the base language 1023, and the method continues accordingly. In this exemplary case, no further terms are found, and the final translational phrase “el libro interesante” is substituted for the original base language phrase “the very interesting book.”

It will be understood by one of ordinary skill that, in order to implement this method in software, the computer program must have access to additional meta-information about the words in the base language and/or second language. By way of example and not limitation, to determine whether to use “el” or “la,” the program must have meta-data indicating that these are gender-specific articles, and which article corresponds to which gender (“el” being masculine and “la” being feminine), as well as similar data for the noun libro, which is masculine in Spanish.

The step of determining which words to translate may be carried out using a number of factors, alone or in combination. The determination may use adaptive language learning. Adaptive language learning gradually and incrementally weaves the second language into the user's everyday life based on the user's linguistic or other language tendencies or patterns. For example, the method begins by substituting words the user uses or encounters more frequently with the corresponding word or term from the second language. As the user becomes proficient with the newly translated word, this word is considered mastered, and is substituted on a consistent basis, and the method then begins to substitute/translate a second tier of words, defined as the most frequently encountered words not already mastered. Determining the point of mastery is a matter of both algorithmic tuning and user feedback and customization, slowing or accelerating the rate at which new words/phrases are translated into the target language based on user settings and/or feedback.

In an embodiment, the determination may include, among other things, profile language learning, which is based on factors specific to the user, such as the user's interests, professional, location, and/or hobbies. This information is generally provided by the user in connection with the user registration process. When a user registers, he or she may provide information about himself or herself that is used to create a user profile which may contain user-supplied information about the user's interests, professional or personal background, geographical location, and so forth. The systems and methods described herein may analyze words associated with users having similar user profile characteristics, in whole or part, to identify commonly encountered words and phrases among such users. Such commonly encountered words and phrases within a given group with a shared background may be given higher priority for translation.

By way of a non-limiting example, suppose that users geographically located within the city of Chicago collectively encounter the word “Chicago” more often than users located elsewhere. Through profile analysis, which can determine trending words amongst user profiles having one or more similar or common background elements, the systems and methods may determine that the word “Chicago” is encountered more often amongst those users in the Chicago area and introduce a translation to the word “Chicago” in another language for such users, including new, future users who register and indicate that they are geographically located in Chicago, even though such users were not part of the original sample group from which this determination was made. This technique may further be used to identify regionalisms in native languages (e.g., regional preferences for term “pop” vs. “soda”).

In another embodiment, the determination may include, among other things, instructor-driven language learning. In such an embodiment, an instructor may determine a preset curriculum comprising specific words for translation for an amount of time. The instructor would be able to monitor the number of encounters with those suggested words and determine areas of weakness for each user. This would allow an independent human to exercise discretion and judgment concerning which specific terms the user should be encountering as translations.

In another embodiment, the determination may include, among other things, article recommendation for language learning. Similar to profile learning, based on the user's interests and reading history, articles may be recommended to the user that are rich with words the user is in the process of learning, but which articles also comport with the user's interest profile. This both increases the user's desire to read and understand the content, and provides familiar context for unknown terms, improving the chances of understanding the translation in context.

In another embodiment, the determination may include, among other things, real-time tracking language teaming. In such an embodiment, as a user progresses through the personalized adaptive model, he or she will receive updates on the words learned, words in the process of being learned, and words that will soon be learned. Each user's progress is unique and will involve different sets of words, based on the user's rate of acquisition, interests, and behavior (e.g., browsing patterns). This enables the system to facilitate the learning of the aspects of language used most often. This differs substantially from conventional language acquisition, such as in a classroom setting or via pre-recorded materials, where users are taught those aspects of the second language believed important by whomever establishes the curriculum. This typically results in such materials focusing on terms relevant to travel and tourism, such as ordering food, which may not be of interest to every user.

In an embodiment, the determination may include, among other things, language learning customization. In such an embodiment, the language learner has the ability to add words in the base language as words the learning would like to begin learning in the target language. For example, if the user enjoys soccer, he may add terms such as “goal,” or “team” to the database, which would then be selected for translation according to the systems and methods described herein.

In an embodiment, the determination may include, among other things, virtual assistant integration. In such an embodiment, the user may interact verbally with a virtual assistant. Words or phrases that are determined to be within the user's learned or mastered vocabulary will be spoken in the second language. Additionally, when the user is engaging the virtual assistant, if a command given in the base language includes words that are indicated in the database to be mastered in the target language, the virtual assistant may request that the command be given again in the target language.

In an embodiment, the determination may include, among other things, crowdsourcing elements. For example, as users gain more proficiency and it is determined that a user has mastered specific words, the occurrence of those words may be editable. For example, the user may be able to correct erroneous translations to ensure proper conjugation and idiomatic usage. User-correction will help address one of the main errors introduced in machine translation: the management of properly translating polysemes. By first identifying bilingual users and then leveraging the knowledge they possess of two languages, the systems and methods can translate material more accurately by utilizing such crowdsourced input. By having such users correct translations on commonly viewed material, users will encounter the modified/correct version of the translation provided by other expert users.

In an embodiment, expert users may also participate in translating to different dialects of a language. This has the advantage of allowing the system to translate not just to a second language but to a particular dialect, including regional variations of that language. This technique will be generally based upon geographic location. By way of a non-limiting example, at Spanish/English expert user situated in the southeastern part of the United States may encounter the Spanish word “refresco” (referring generally to carbonated beverages) translated to “soda” and correct the translation to be “coke,” a regional synonym. By contrast, a user located in Chicago might translate the same word to the English equivalent of “pop,” a preferred term in the Chicago area. This data may be stored and retrieved by the systems and methods, and used in determining how to translate terms, in order to accommodate regional dialects and variations. That is, the system develops over time a body of knowledge that users in a given geographic area A tend to correct “refresco” to “coke,” whereas users in another geographic area B tend to translate to “pop,” and still other users in area C translate to “soda.” Thus, when the term “refresco” is subsequently being translated for another user, the geographic location of that user can be used to determine which translation to use—if the user is in area A, “coke” is the translation; if B, “pop,” and so on. With a sufficiently large user base using this learning method, the database will ultimately comprise an online script completely and properly available in the user's target language.

Similarly, crowdsourcing challenges may be introduced. For example, common phases may appear in the user's target language, and the user will be asked to translate the phrase to the base language. This will provide information on regional, local and other colloquial usage. The user's location can also be included with such data, allowing the database and translations to further account for regional and local variations. For example, most English-speaking users in Iowa would translate the Spanish term “refresco” to the English “pop,” but most English-speaking users in Missouri would translate the same term to the English “soda.” The location-based aspects of these translations can be captured and used in reverse-translations to identify regionalisms. For example, when a Spanish-speaking user located in Missouri is attempting to learn English as the target language, “refresco” in the base language may translate to “soda” in the target language. However, another Spanish-speaking user located in Iowa would receive the translation “pop,” based on bow English-speaking users in each locale have differently translated “refresco.”

One of ordinary skill will appreciate that any number of techniques and architectures are suitable for implementing a persistent data store with local access and caching, which facilities speed, portability, and data security. The depicted embodiment is just one such arrangement and should not be understood as a limiting disclosure. For example, techniques are well-known in the art to directly access the persistent data storage, removing the need for an intermediate cache. The software and databases described herein are exemplary only, and any number of computer programming languages and development platforms could be used to create the software described herein. The programming techniques and acumen required to create and operate the systems and methods according to the present disclosure are generally within the ability of one of ordinary skill in the art,

Turning to a further embodiment, the second language acquisition method and devices may be employed in audio and video formats. The devices in this embodiment preferably have an electronic screen, as described above, but for audio only formats the screen is not necessary.

For use in strictly audio tracks, like reading a book on tape, words will initially be spoken at lower translation ratio. New target language words will be inserted into the spoken text in place of base language words, and by the end of the audio track, the target language words will be spoken at a higher translation ratio. One variation of this embodiment allows that when a screen is present, a target language word is first introduced on the audio track, and the spelling and/or pronunciation of word is quickly, but preferably not subliminally, flashed on a screen. The learner would be able to learn the proper pronunciation and spelling of the introduced target word. The learner would then preferably be provided a forum to give feedback to the program on how well the learner learned each target language vocabulary word and the program would again adjust the rate of transition based off of this feedback. The learner could interact directly or with some manner of remote control.

A variation of this embodiment calls for multiple audio tracks for a video program, with at least one in the base language and one in the target language. Each spoken word in the base language will be logged with its location in the audio track. The program will then slowly and sequentially replace base language words with target language words as above with the text embodiments. The video programs will preferably have closed caption type text elements associated with the audio that can show up on the screen as the dialog is spoken. In one embodiment, the caption as presented can remain in the base language even when a spoken word is presented in the target language. Preferably though, the caption will follow the language of the spoken dialog. Words spoken in the base language would be captioned on the screen in the base language and words spoken in the target language would be captioned on the screen in the target language. The learner can interact with the program through a wireless device, like a remote control or cellular phone for example. If the learner is getting lost and/or either doesn't know or cannot figure out the meaning of a target language word used, the learner can press a button on the remote control to signal such to the program. The program can then pause the video and give one or more cues as described above. The learner may also moderate the transition rate up or down depending on the comfort level of the learner with the target language.

Alternatively, a single audio track may be included with words in both the base language and the target language, but each word usage being in only one of the two languages.

While is it understood that the second language acquisition device and method can be incorporated in a single movie or television program, the device and method can be used well with multiple episodes of the same program, similar to the manner in which multi-volume book series are well suited for the disclosed device and method. Further, multi-episode dramas and sitcoms, for example, are now available from video streaming services and DVD sets. These programs could incorporate the gradual base to target language transition approach described above and thereby help a viewer/learner build a target language vocabulary passively by watching the stories unfold across the many episodes and/or seasons of programs. This very low effort approach would aid in teaching learners how to properly pronounce the target language words instead of just recognizing the written text.

In another embodiment of the second language acquisition device and method, the computer program recognizes material viewed on to learner's computer or other type of screen and gradually, over time translates material from the base language to the target language. The program could introduce one new target language word every five to ten minutes, or every hour. The program would recognize and translate material on websites, other computer programs, and desktop functions, according to the above invention. For example, when viewing a news article on a website, the program will selectively translate words in the news article. Additionally, functions or other instances where text is displayed on other programs, such as Microsoft Word, the second language acquisition program could also selectively change the displayed wording from the base language to the target language for select words. For example, The ‘Paste’ Icon in Word could become ‘Cinta’ as it is in the Spanish version of Microsoft® Word®. Clicking the mouse on a target language word (or clicking with Shift key depressed for example) could indicate to the second language acquisition program that the learner is unfamiliar with the clicked word and prompt the program to start providing one or more cues, and then, at some point, provide the base language translation for the target language word.

According to a still further embodiment, the second language acquisition device can recognize the learner's speech pattern. In this embodiment, the program could collect samples of the learner's speech, analyze the learner's speech patterns and identify commonly used words and phrases. Using this information, the program can then prioritize the words more commonly used by the learner, and inject these words and phrases into the other applications. This will enable the program to quickly impact the learner's daily speech by learning and targeting vocabulary that the learner already commonly uses in the learner's native tongue. The program can be given a head start on common speech patterns of the learner by the learner tilling out a biography including a questionnaire asking about the user's occupation, education, interests, and regional dialect. The program can gain user speech pattern information from a variety of sources, including cell phone calls, computer microphones, wearable electronics, and other audio collecting devices.

Additionally, the learner can demonstrate to the program, by using speech, that the learner is learning the target language. Through using learned target language vocabulary words in speech, the learner can cause the program to increase the rate of transition by reaffirming that the learner has mastered target language vocabulary words. If the learner mispronounces a target language word, the program could continue to re-teach the user the word and/or the word's pronunciation, until the learner is able to properly pronounce the target language word.

Additionally, by analyzing the context in which the learner is speaking the target language words, the program could also identify if the learner is using the word grammatically or otherwise correctly. If the learner is able to pronounce the words correctly, but is misusing the word, the program will give the learner additional context until the learner is familiar with both the correct pronunciation and use of a given word. The use of a word could include correct meaning, grammar, syntax, and connotation. For example, the words of the phrase “Johnny walked house” have basically the same meaning as the words of the phrase “Johnny walked home,” but the first phrase is substantially unintelligible. The program could help correct misuses such as these that are patently obvious to native speakers but largely a mystery to non-native speakers.

Additionally, the program can keep track of the target language words that the program concludes that the learner has learned or acquired using the second language acquisition device and method in the various medium, for example, video, ebook, etc. The different applications/devices could interact with each other such that the learned or acquired words could be automatically presented in the target language. In this way, all the applications could be linked, so progress in one application would be reflected in all other applications (i.e., if “carro” was learned in an e-book, all future encounters of the word English word “car” in the wearable technology and audio/visual applications could be presented translated automatically into the target language “carro”). Alternatively, a word considered acquired while viewing the internet on partially translated pages could be automatically considered acquired when starting a video or an ebook.

The various second language acquisition devices could communicate wirelessly with one another or the second language acquisition device in use could display a sixteen to twenty character code at any point of use. For example, when entered into another second language acquisition device, would tell the another second language acquisition device where the learner is with respect to words learned/acquired and could also contain information as to number of times the learner has been exposed to different target language words, and other information about the user's experience and goals with the second language acquisition device and method. The hard bound books could also have a code at the end of the book that could be inputted into electronic second language acquisition devices to input information about the users experience with target words with the hard bound book.

According to a further embodiment, when all or substantially all of the words in a textual or spoken phrase are “learned” or otherwise to be presented in the target language, and the phase, if natively presented in the target language would be in different word order than that presented in the base language, the program would preferably present the phrase of words in the target language in the native (grammatically correct) order. For example, if the words of the phase “the big green boat” were all considered by the program to be learned by the learner, if the phrase is to be presented in a story multiple times. Instead of presenting the words in target language (here Spanish) in the English order as “el gran verde barco,” the words would be in the target language order, “el gran barco verde.”

In a further embodiment, the program can present the learner with a list of the words in an e-book or audio/video program. The list can be in alphabetical order, order of number of times used in the story, order of frequency used in the culture, order of frequency used in different situations (travel, restaurant, business, social), or order of frequency used in different occupations (medical, military, teacher, IT service), for example. The program could allow the learner to manually tick the words that the program would teach in a given story, tick words that the learner had already learned or acquired, and/or tick words that the user had learned but wanted to refresh. The words to learn would be presented to the user in the fashion as words automatically selected for translation as described, elsewhere herein. The acquired words would be automatically replaced with the words from the target language when they were encountered in the story. The words to refresh would be re-taught, but at an accelerated learning pace or could be presented in the target language with an automatic cue on the first occurrence in the story of the word to refresh.

The rate of transition in the electronic applications will be determined by an process or method designed to identify commonly used words that are able to be contextualized, human language learning limitations, individual learner's learning rates, and individual learner's reading rates. Human language learning limitations will be based off of the understanding that it takes 4-12 encounters of new information to be able to recall information. Additionally, the process or method will repeatedly expose the learner to this information for a sufficient amount of time to ensure the learner is able to retain the information. The individual learner's learning rate will be determined from their feedback or lack of feedback when exposed to target language vocabulary. If the learner has to ask for more context on every word the learner encounters, every time the learner encounters them, the program will slow the rate of transition. The user's reading rate will be used to determine how much, if any, target language words are distracting the learner from the story. The learner will be given the ability to choose how much of their baseline reading rate they are willing to sacrifice and then the program will only translate enough words to keep the rate of transition and the percentage of baseline reading rate at optimal levels. This will ensure that the reader does not get overwhelmed by the foreign vocabulary and are still able to be engaged in the story. Printed text versions will be created at a set rate of transition. This rate will be based off of established learning methods as previously discussed or number of encounters to learn new information and a sufficient number of repetitions after learned to ensure that the reader retains the information for extended periods of time.

According to a further embodiment, Teacher Reports/User Reports may be created. Electronic versions of the technology may be linked so a learner can control the rate of transition from the base language, to the target language across all mediums that the learner uses the second language acquisition program. The learner will also be able to share the learner's progress via a digital report, which will track the vocabulary learned, rate of transition, foreign vocabulary used and other achievements in target languages. The digital report will allow the learners to select the proper learning levels of printed text as well. Additionally, teachers using the e-book, computer software, or wearable technology versions, will be able to program vocabulary words they want their students to learn while also receiving a live summary of their students progress.

According to a still further embodiment, the learner's progress could be tracked, shared, and displayed on one or more social media networks. This social media display could be through generating a shared social-media post congratulating the learner and listing any progress made in the target language, for example.

According to a further embodiment, the rate of transition may be moderated to account for a rate of frustration of the learner. The rate of frustration could be determined based on a questionnaire, social media data, or body data monitoring.

While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of and “consisting only of are to be construed in the limitative sense.

1. A method of partially translating an electronic document comprising:
providing a client computer having a display;
providing a remote computer server communicatively coupled to said client computer device over a telecommunications network;
receiving at said client computer an electronic document comprising written content in a first language;
at said client computer, selecting a plurality of words in said written content and, for each such selected word, counting the number of times said word occurs in said written language content;
at said client computer, sending to said remote computer a first datagram comprising said selected plurality of words and said count of occurrences of each of said plurality of words;
receiving from said remote computer a second dam ram comprising:
a second plurality of words, said second plurality of words being a subset of said first plurality of words;
for each word in said second plurality of words, a corresponding translation of said word into a second language; and
at said client computer, displaying said received electronic document on said display, said displayed electronic document modified such that each occurrence in said displayed electronic document of a word in said second plurality of words is substituted fir said corresponding translation of said word into said second language.

2. The method of claim 1, wherein said client computer is a mobile device.

3. The method of claim 2, wherein said client computer is a smart phone or tablet computer.

4. The method of chum 1, wherein said received electronic document is a web page.

5. The method of claim 1, wherein the proportion of said selected plurality of words in said written content translated into said second language in said second plurality of words increases over time.

6. A system for partially translating an electronic document comprising:
an application server computer comprising a microprocessor and a non-transitory computer-readable storage medium having computer-readable instructions thereon which, when executed by said microprocessor, perform the steps of:
receiving at said server a request including a word list comprising a plurality of words in a first language and, for each word in said word list, a count of occurrence of said each word in a document;
selecting a plurality of words in said word list for translation, said selected plurality of words being based at least in part upon said count of occurrences for each word in said selected plurality of words;
determining a translation of said each word in said selected plurality of words into a second language; and
responding to said received word list with a second word list comprising said selected plurality of words and, for each said word in said selected plurality of words, said determined translation of said. each word.

7. The system of claim 6, wherein said request further comprises a user identifier associated with a user.

8. The system of claim 7, wherein said selecting a plurality of words in said word list for translation is further based at least in part upon user profile data for said user associated with said user identifier.

9. The system of claim 7, wherein said selecting a plurality of words in said word list for translation is further based at least in part upon historical data about counts of occurrences for each word in said selected plurality of words for said user associated with said user identifier.

10. The system of claim 7, wherein said selecting a plurality of words in said word list for translation is further based at least in part upon a preset curriculum of words. 11, The system of claim 7, wherein said selecting a plurality of words in said word list for translation is further based at least in part upon words identified by an instructor for translation fur said user associated with said user identifier.

12. The system of claim 7, wherein said selecting a plurality of words in said word list for translation is further based at least in part upon customization and configuration data provided by said user associated with said user identifier.

13. The system of claim 7, wherein said selecting a plurality of words in said word list for translation is further based at least in part upon words identified for translation by said user associated with said user identifier.

14. A method for partially translating an electronic document comprising:
providing an application server computer;
receiving at said server a request including a word list comprising a plurality of words in a first language and, for each word in said word list, a count of occurrence of said each word in a document;
said application server selecting a plurality of words in said word list for translation, said selected plurality of words being based at least in part upon said count of occurrences for each word in said selected plurality of words;
said application server determining a translation of said each word in said selected plurality of words into a second language; and
said application server responding to said received word list with a second word list comprising said selected plurality of words and, for each said word in said selected plurality of words, said determined translation of said each word.

15. The method of claim 12, wherein said request further comprises a user identifier associated with a user.

16. The method of claim 13, wherein said selecting a plurality of words in said word list for translation is further based at least in part upon user profile data for said user associated with said user identifier.

17. The method of claim 13, wherein said selecting a plurality of words in said word list for translation is further based. at least in part upon historical data about counts of occurrences for each word in said selected plurality of words for said user associated with said user identifier. 18, The method of claim 13, wherein said selecting a plurality of words in said word list for translation is further based at least in part upon a preset curriculum of words.

19. The method of claim 13, wherein said selecting a plurality of words in said word list for translation is further based at least in part upon words identified by an instructor for translation for said user associated with said user identifier. 20, The method of claim 13, wherein said selecting a plurality of words in said word list for translation is further based at least in part upon words identified for translation by said user associated with said user identifier.
